(19) United States
(12) Patent Application Publication
(10) Pub. No.: US 2006/0010122 A1
(43) Pub. Date: Jan. 12, 2006

(54) System and method for improved database table record insertion and reporting

(75) Inventors: Sudhakar Velkanthan Chellam, Apex, NC (US); Chrystian Ludwig Plachco, Morrisville, NC (US)

Correspondence Address: VAN LEEUWEN & VAN LEEUWEN, P.O. BOX 90609, AUSTIN, TX, 78709-0609, US

(73) Assignee: International Business Machines Corporation, Armonk, NY (US)

(21) Appl. No.: 10/886,753

(22) Filed: Jul. 7, 2004

(51) Int. Cl. G06F 17/30

(52) U.S. Cl. 707/4

(57) ABSTRACT

A system and method for improving table generation performance is presented. A record manager receives timestamped records from a client. The record manager uses the record's timestamp, a time interval, and a total tables number in order to identify a particular table from a plurality of tables. Once identified, the record manager stores the record in the particular table. The record manager may also receive a report request that corresponds to a particular timeframe. When the record manager receives a report request, the record manager uses the timeframe, the time interval, and the total tables number in order to identify a table that corresponds to the report request's timeframe. Once it identifies the corresponding table, the record manager uses the records that are located in the table to generate the report.

### BACKGROUND OF THE INVENTION

1. Technical Field

The present invention relates in general to a system and method for improving database table record insertion and reporting. More particularly, the present invention relates to a system and method for using timestamps that correspond to records in order to organize the records into multiple tables, which, in turn, are used to generate time-dependent reports.

2. Description of the Related Art

Large companies store an enormous amount of customer support inquiry data. Organizations make decisions, and service customers, based upon data they collect. A company may use the stored data to examine business trends to establish a strategy for the future. For example, a company may identify that a particular business area is receiving an unusually number of customer inquiries, and may increase staff to accommodate the situation. In addition, when a particular customer calls, the company is able to identify the customer's call history corresponding to a particular issue (e.g. customer complaint).

Companies may record customer inquiries using a few different approaches. For example, a customer may call a customer support representative whereby the customer support representative creates a record corresponding to the phone call. In another example, a customer may use a company's website to send an online inquiry, in which the online inquiry, along with its response, may be logged. A company may store hundreds of thousands of customer inquiries in a given week. This may equate to the company storing millions of customer inquires during a particular year, all of which are stored in a single table.

A challenge found with storing a large number of records in a single table is that it becomes extremely time intensive to generates reports, or find a particular record in a large table. Using a large table to search and retrieve records to include in a report results in slow database response-time and affects the whole database performance.

In addition, another challenge found is that a company may simultaneously generate multiple reports using a single large database. In this situation, the report generation process slows even more.

What is needed, therefore, is a system and method to improve report generation performance that corresponds to a large amount of records.

### SUMMARY

It has been discovered that the aforementioned challenges are resolved by using a record manager to store records in a plurality of tables based upon a record's corresponding timestamp. By using a plurality of tables to store records, the number of records in each table is decreased, resulting in faster report generation. When the record manager generates a report, the record manager identifies a particular table and uses the records in the table in order to generate the report.

A client generates a record and adds a timestamp to the record. The client sends the record and the timestamp to the record manager, whereby the record manager extracts the record's timestamp, and retrieves a “time interval” and a “total number of tables” from a storage area. The time interval is an amount of time that is associated with the records that are stored in each table. For example, a time interval may be one week whereby each table stores a particular week's worth of records. The total number of tables is the amount of tables that the record manager uses to store records, such as ten tables.

The record manager uses the time interval, the total number of tables, and the timestamp to determine which table to store the record. In one embodiment, processing may use the formula
(Timestamp/Interval) %(Total Number Tables)=Table Number

where “%” is the remainder after division. For example, if the interval is 86400000 (i.e. 24 hours in milliseconds), the current time is 1084571611014, and the total tables number is 10, then

Timestamp/interval=12552

12552/10=1255, with 2 as the remainder

Therefore, since “2” is the remainder, the second table is identified as the table to store the record that has the corresponding timestamp of 1084571611014.

The record manager may also receive report requests from a database administrator. A report request may include a particular timeframe that corresponds to the database administrator's interest. For example, the database administrator may wish to receive a report that categorizes customer complaints that its company received during a particular month. When the record manager receives a report request, the record manager uses the timeframe, the time interval, and the total tables number in order to identify the table that corresponds to the report request's timeframe. Once it identifies the corresponding table, the record manager uses the records that are located in the table to generate the report.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram showing a record manager storing records based upon the record's corresponding timestamps;

FIG. 2 is a diagram showing multiple tables whereby each table includes multiple records that correspond to a particular timeframe;

FIG. 3 is a high-level flowchart showing steps taken in storing a record, generating a report, and analyzing table records;

FIG. 4 is a flowchart showing steps taken in storing a record using the corresponding timestamp;

FIG. 5 is a flowchart showing steps taken in generating a report based upon a particular timeframe;

FIG. 6 is a flowchart showing steps taken in analyzing an amount of records that are included in tables, and increasing the total number of tables if appropriate; and

FIG. 7 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

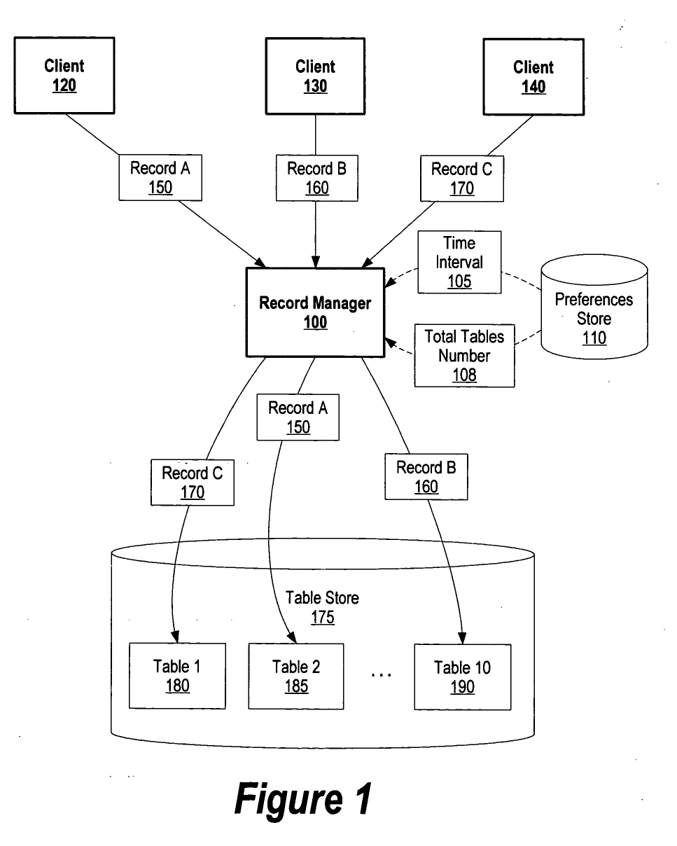

FIG. 1 is a diagram showing a record manager storing records based upon the record's corresponding timestamps. Record manager 100 is responsible for receiving records from clients, such as clients 120, 130, and 140, and storing the records in a particular table that is located in table store 175. Table store 175 may be stored on a nonvolatile storage area, such as a computer hard drive.

Client A 120 timestamps record A 150, and sends record A 150 to record manager 100. Record manager 100 extracts record A 150's timestamp, and also retrieves time interval 105 and total tables number 108 from preferences store 110. Time interval 105 is an amount of time that is associated with the records that are stored in each table. For example, a time interval may be one week whereby each table stores a particular week's worth of records. Total tables number 108 is the total number of tables that record manager 100 uses to store records. The example in FIG. 1 shows that there are a total of ten tables that are located in table store 175. Preferences store 110 may be stored on a nonvolatile storage area, such as a computer hard drive.

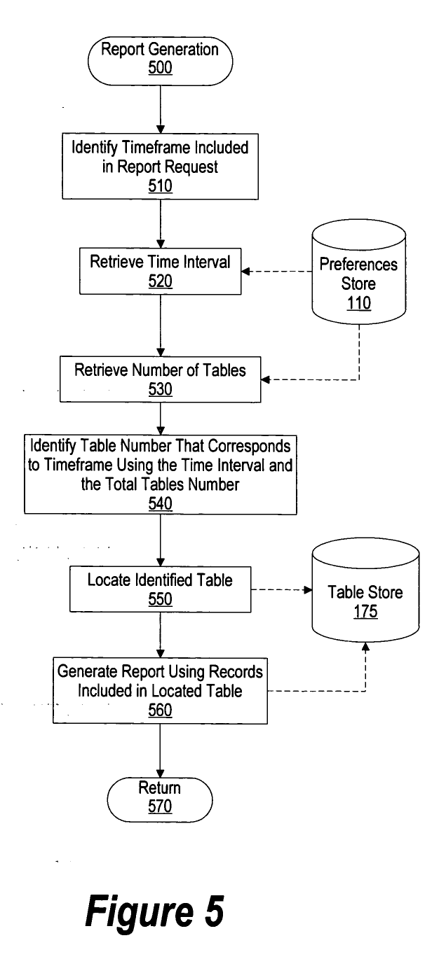

Record manager 100 uses time interval 105 and total tables number 108 to determine which table to store record A 150 (see FIG. 5 and corresponding text for further details regarding record storage steps). The example in FIG. 1 shows that record manager 100 stores record A 150 in table 2 185. In one embodiment, record A 150 may not include a timestamp. In this embodiment, record manager timestamps record A 150 when it receives the record.

Record manager 100 proceeds to receive record B 160 and record C 170 from client 130 and client 140, respectively. Record manager 100 uses record B 160's timestamp, time interval 105, and total tables number 108 in order to determine which table to store record B 160. The example in FIG. 1 shows that record manager 100 stores record B 160 in table 10 190. In addition, record manager 100 uses record C 170's timestamp, time interval 105, and total tables number 108 in order to determine which table to store record C 170. The example in FIG. 1 shows that record manager stores record C 170 in table 1 180.

Record manager 100 may also receive a report request from a database administrator. The report request may include a particular timeframe that corresponds to the database administrator's interest. For example, the database administrator may wish to receive a report that categorizes customer complaints that its company received during a particular month. When record manager 100 receives a report request, record manager 100 uses time interval 105 and total tables number 108 in order to identify the table that corresponds to the report request's timeframe. Once it identifies the corresponding table, record manager 100 uses the records that are located in the table to generate the report (see FIG. 5 and corresponding text for further details regarding report generation).

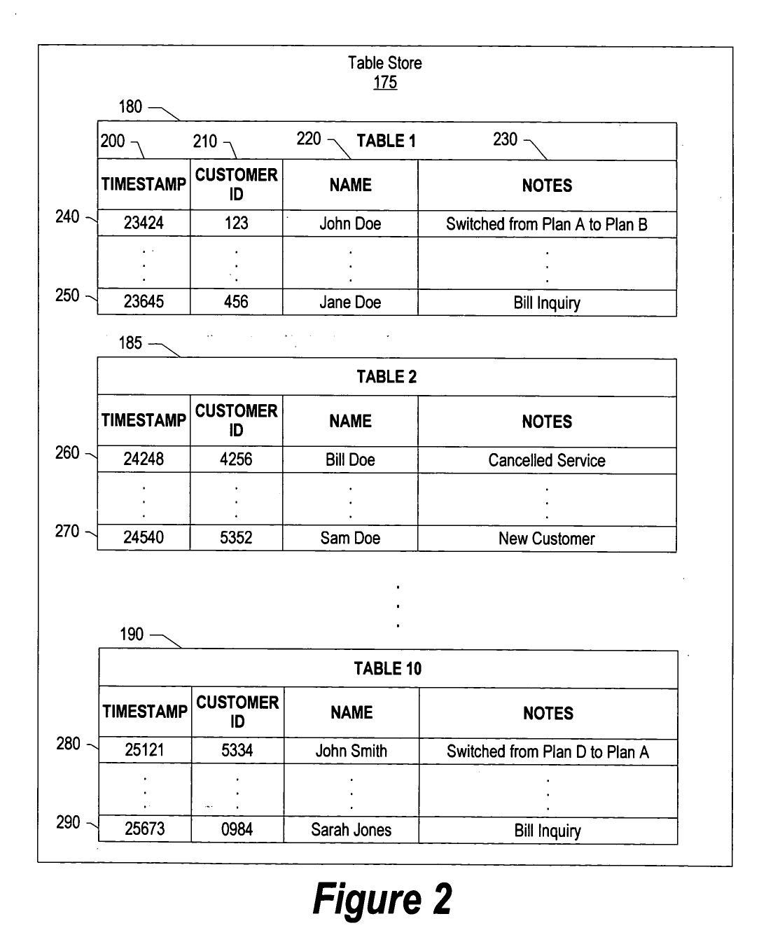

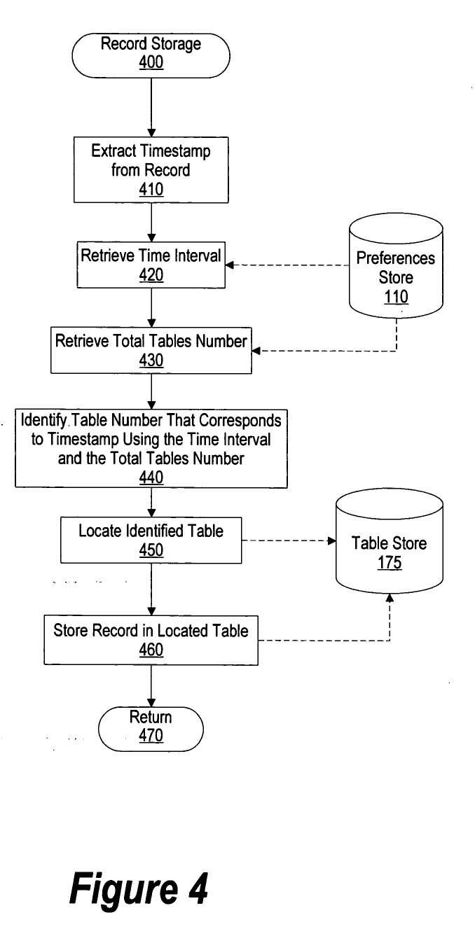

FIG. 2 is a diagram showing multiple tables whereby each table includes multiple records that correspond to a particular timeframe. A record manager uses a record's timestamp in order to determine which table the record should be stored (see FIG. 4 and corresponding text for further details regarding record storage). Table store 175 includes ten tables whereby tables 180, 185, and 190 are shown in FIG. 2. Table store 175, table 180, table 185, and table 190 are the same as that shown in FIG. 1.

Table 180 includes columns 200 through 230. Column 200 includes timestamps that correspond to the records that are included in table 180. The timestamp is based upon a particular point in time, such as Jan. 1, 1970. Columns 210 and 220 include a list of customer identifiers and customer names, respectively, that corresponds to table 180's records. Column 230 includes a list of notes that corresponds to table 180's records.

Table 180 includes records 240 and 250. Record 240 has a timestamp of “23424”, a customer identifier of “123” a customer name of “John Doe,” and notes that indicate that the customer switched from plan A to plan B. Record 250 has a timestamp of “23645”, a customer identifier of “456” a customer name of “Jane Doe,” and notes that indicate that the customer's call was to inquire about a bill.

Table 185 includes the same four columns as table 180, and includes records 260 and 270. Record 260 has a timestamp of “24248”, a customer identifier of “4256” a customer name of “Bill Doe,” and notes that indicate that the customer canceled service. Record 270 has a timestamp of “24540”, a customer identifier of “5352” a customer name of “Sam Doe,” and notes that indicate that the customer is a new customer. Note that the timestamps in table 180 start at “23424” whereas the timestamps in table 185 start at a different timestamp of “24248” which corresponds to a different timeframe.

Table 190 also includes the same four columns as table 180, and includes records 280 and 290. Record 280 has a timestamp of “25121”, a customer identifier of “5334” a customer name of “John Smith,” and notes that indicate that the customer switched from plan D to plan A. Record 290 has a timestamp of “25673”, a customer identifier of “0984” a customer name of “Sarah Jones,” and notes that indicate that the customer called to inquire about a bill. Note that the timestamps in table 190 start at “25121,” which corresponds to a different timeframe than tables 180 and tables 185.

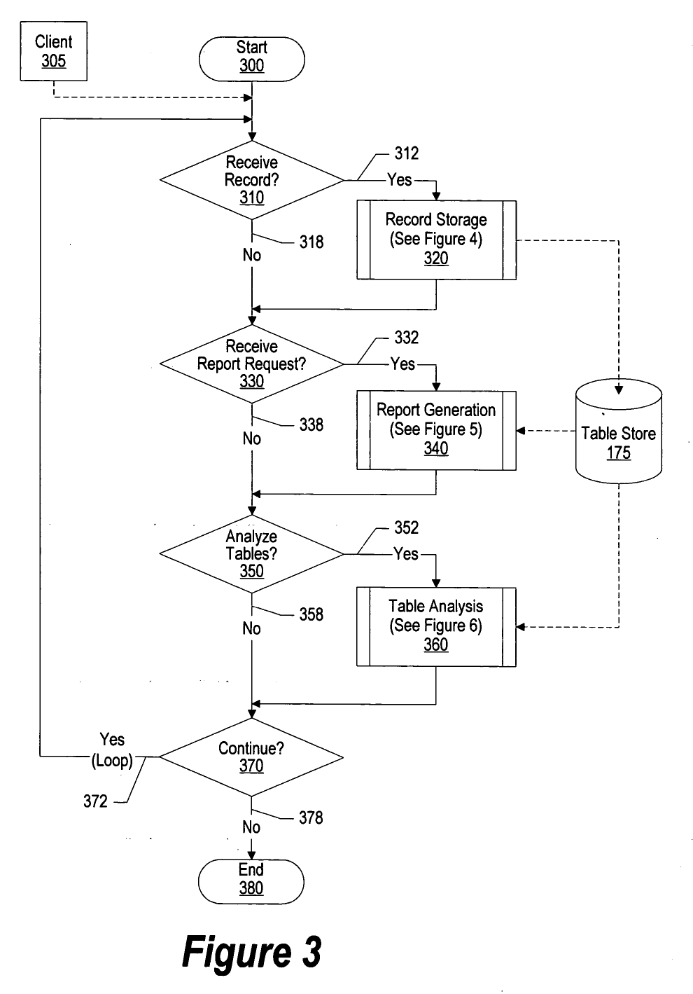

FIG. 3 is a high-level flowchart showing steps taken in storing a record, generating a report, and analyzing table records. Record manager processing commences at 300, whereupon a determination is made as to whether the record manager receives a record from client 305 (decision 310). For example, client 305 may be a customer service representative's computer terminal and the customer service representative logs a customer inquiry that corresponds to a customer phone call.

If the record manager receives a record from client 305, decision 310 branches to “Yes” branch 312 whereupon the record manager uses a timestamp that corresponds with the received record in order to locate a table in table store 175, and store the record in the located table (pre-defined process block 320, see FIG. 4 and corresponding text for further details). Table store 175 is the same as that shown in FIG. 1 and may be stored on a nonvolatile storage area, such as a computer hard drive. On the other hand, if the record manager does not receive a record from client 305, decision 310 branches to “No” branch 318 bypassing record storage steps.

A determination is made as to whether the record manager receives a report request from client 305 (decision 330). For example, client 305 may be a database administrator's computer terminal and the database administrator may wish to receive a report that corresponds to a timeframe, such as a particular month. If the record manager receives a report request from client 305, decision 330 branches to “Yes” branch 332 whereupon processing generates a report using records that are located in one of the tables that are stored in table store 175 (pre-defined process block 340, see FIG. 5 and corresponding text for further details). On the other hand, if the record manager does not receive a report request, decision 330 branches to “No” branch 338 bypassing report generation steps.

A determination is made as to whether the record manager receives a request to analyze table records (decision 350). For example, a database administrator may detect that reports are generated too slowly, which may be due to a table that has an unusually large number of record entries. In this example, the database administrator may wish to analyze the number of records in each table and increase the number of tables in order to decrease the number of records in each table. As one skilled in the art can appreciate, the time at which the number of tables changes should be stored in order to track table locations of past and future record entries.

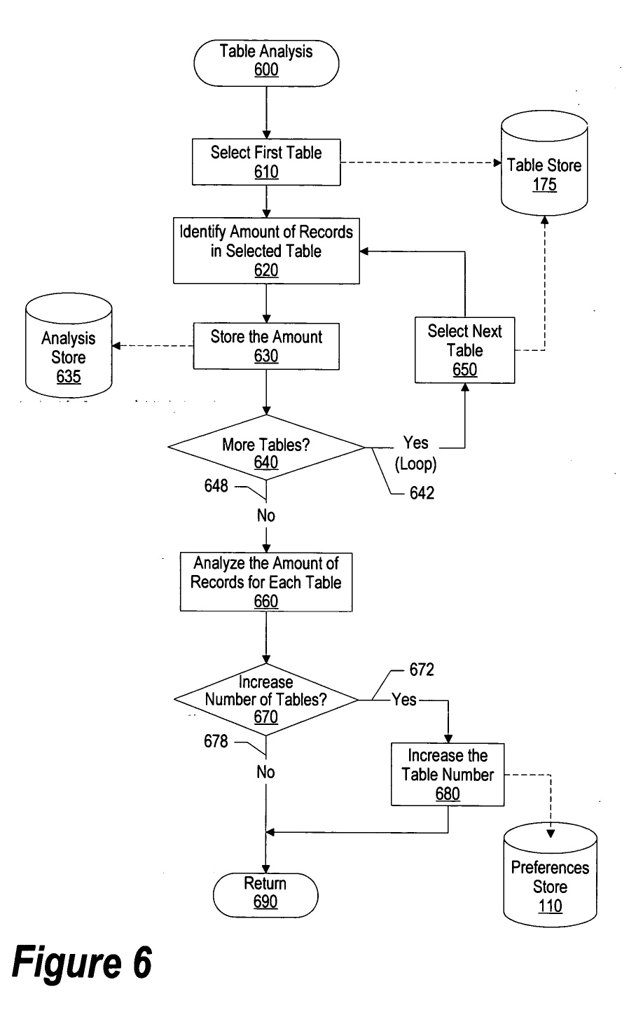

If the record manager should analyze table records, decision 350 branches to “Yes” branch 352 whereupon the record manager analyzes the number of records that are included in the tables that are located in table store 175, and increases the number of tables if appropriate (pre-defined process block 360, see FIG. 6 and corresponding text for further details). On the other hand, if the record manager did not receive a request to analyze the table records, decision 350 branches to “No” branch 358 bypassing table analysis steps.

A determination is made as to whether to continue receiving requests from client 305 (decision 370). If the record manager should continue to receive requests from client 305, decision 370 branches to “Yes” branch 372 which loops back to receive more client requests. This looping continues until the record manager should stop receiving client requests, at which point decision 370 branches to “No” branch 378 whereupon processing ends at 380.

FIG. 4 is a flowchart showing steps taken in storing a record using the corresponding timestamp. Processing commences at 400, whereupon processing extracts a timestamp from the record at step 410. The timestamp is based upon a particular point in time, such as Jan. 1, 1970. In one embodiment, the record may not include a timestamp and, in this embodiment, a record manager may timestamp the record when the record manager receives the record.

Processing retrieves a time interval from preferences store 110 at step 420. The time interval is an amount of time that is associated with the records that are stored in each table. For example, a time interval may be one month whereby each table stores a particular month's worth of records. Preferences store 110 is the same as that shown in FIG. 1 and may be stored on a nonvolatile storage area, such as a computer hard drive.

Processing retrieves a total tables number from preferences store 110 at step 430. The total tables number is the total number of tables that a record manager uses to store records. Using the example described above, a record manager may use twelve tables whereby each table corresponds to a particular month in a given calendar year.

At step 440, processing uses the timestamp, the time interval, and the total tables number to identify a table number that corresponds to the record's timestamp. In one embodiment, processing may use the formula
(Timestamp/Interval) %(Total Tables Number)=Table Number

where “%” is the remainder after division. For example, if the interval is 86400000, the current time is 1084571611014, and the total tables number is 10, then

Timestamp/interval=12552

12552/10=1255, with 2 as the remainder

Therefore, since “2” is the remainder, the second table is identified as the table to store the record that has the corresponding timestamp of 1084571611014.

Processing locates the identified table in table store 175 at step 450, and stores the record in the located table at step 460. Table store 175 is the same as that shown in FIG. 1, and may be stored on a nonvolatile storage area, such as a computer hard drive. Processing returns at 470.

FIG. 5 is a flowchart showing steps taken in generating a report based upon a particular timeframe. A record manager receives a request to generate a report that corresponds to a particular timeframe. For example, a database administrator may wish to view a report that groups customer complaints into categories that it received during a particular month.

Processing commences at 500, whereupon the report manager identifies a timeframe that is included in the received report request at step 510 (e.g. one month). At step 520, the report manager retrieves a time interval from preferences store 110. A time interval is an amount of time that is associated with the records that are stored in each table. For example, a time interval may be one month whereby each table stores a particular month's worth of records. Preferences store 110 is the same as that shown in FIG. 1 and may be stored on a nonvolatile storage area, such as a computer hard drive.

Processing retrieves a total tables number from preferences store 110 at step 530. The total tables number is the total number of tables that a record manager uses to store records. Using the example described above, a record manager may use twelve tables whereby each table corresponds to a particular month in a given calendar year. At step 540, the record manager uses the time interval and the total tables number to identify a table that corresponds to the report request's timeframe. In one embodiment, processing may use the formula
(Timeframe/Interval) %(Total Tables Number)=Table Number

where “%” is the remainder after division. For example, if the interval is 86400000, the timeframe is 1084571611014, and the total tables number is 10, then

Timestamp/interval=12552

12552/10=1255+2 as the remainder

Therefore, since “2” is the remainder, the second table is identified as the table to use for report generation. In one embodiment, the timeframe may have a start and a stop time. In this embodiment, processing may use the above formula for both times, and, if the remainder of the start time is different from the remainder of the stop time, processing uses a plurality of tables during the report generation.

Processing locates the identified table in table store 175 at step 550. At step560, processing generates a report using the records that are included in the identified table. Table store 175 is the same as that shown in FIG. 1, and may be stored on a nonvolatile storage area, such as a computer hard drive. Processing returns at 570.

FIG. 6 is a flowchart showing steps taken in analyzing an amount of records that are included in tables, and increasing the total number of tables if appropriate. Table analysis processing commences at 600, whereupon a record manager selects a first table that is located in table store 175 at step 610. Table store 175 is the same as that shown in FIG. 1 and may be stored on a nonvolatile storage area, such as a computer hard drive. The record manager identifies the number of records, such as 500,000 records, that are included in the first table (e.g. 500,000 records) at step 620, and stores the number of records in analysis store 635 at step 630. Analysis store 635 may be stored on a nonvolatile storage area, such as a computer hard drive.

A determination is made as to whether there are more tables to identify their number of records (decision 640). If there are more tables to identify their number of records, decision 640 branches to “Yes” branch 642 whereupon processing selects (step 650) and processes the next table. This looping continues until there are no more tables to process, at which point decision 640 branches to “No” branch 648 whereupon processing analyzes the amount of records that are included in each table. For example, each of the existing tables may cover a timeframe of one month, and processing analyzes the number of records in each month and determines that there are such a large number of records in each month, that the number of tables should be doubled. In addition, the timeframe of each table is shortened to two-week intervals. In this example, and as one skilled in the art can appreciate, the time at which a change is made to the total number of tables should be stored in a storage area in order for the record manager to use during future record storage and report generations.

In one embodiment when the number of tables is increased, a database manager may choose to start a new database to store records. For example, the database manager may perform an analysis every two years and, after the analysis, the database manager may archive the existing database and start a new database. In this example, the database manager may increase the number of tables every two years without increasing the complexity of identifying which table to use during record storage and report generation.

A determination is made as to whether to increase the number of tables based upon the analysis (decision 670). If the report manager, or database administrator, wishes to increase the number of tables, decision 670 branches to “Yes” branch 672 whereupon processing increases the number of tables and stores the new total tables number in preferences store 110 (step 680). Preferences store 110 is the same as that shown in FIG. 1 and may be stored on a nonvolatile storage area, such as a computer hard drive. On the other hand, if the record manager or database administrator does not wish to increase the total number of tables, decision 670 branches to “No” branch 678. Processing returns at 690.

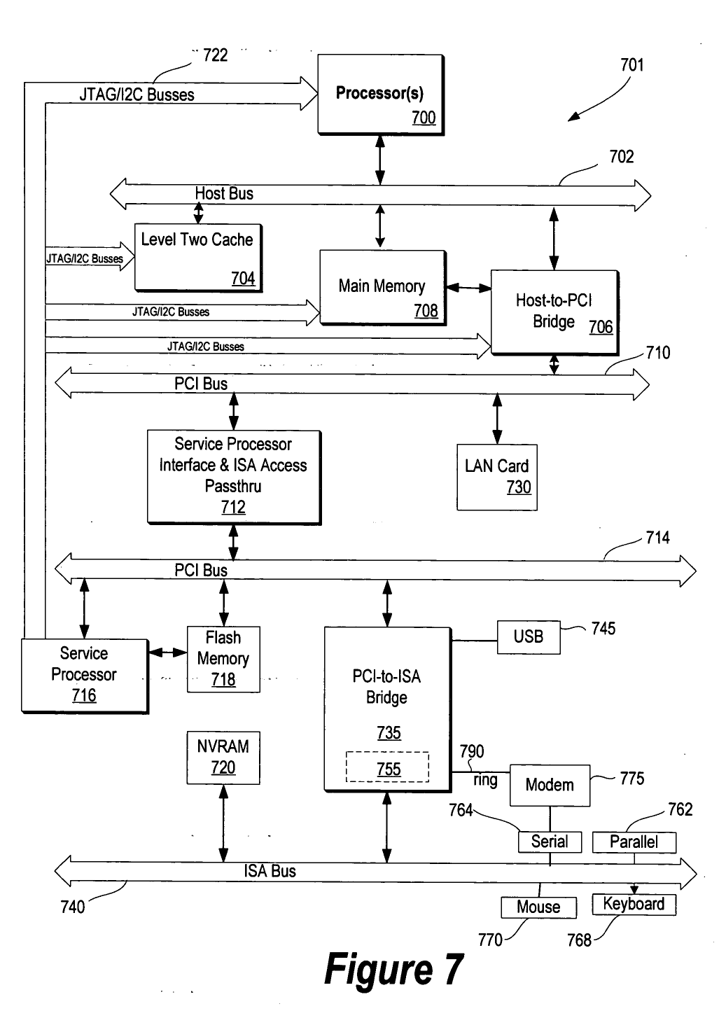

FIG. 7 illustrates information handling system 701 which is a simplified example of a computer system capable of performing the computing operations described herein. Computer system 701 includes processor 700 which is coupled to host bus 702. A level two (L2) cache memory 704 is also coupled to host bus 702. Host-to-PCI bridge 706 is coupled to main memory 708, includes cache memory and main memory control functions, and provides bus control to handle transfers among PCI bus 710, processor 700, L2 cache 704, main memory 708, and host bus 702. Main memory 708 is coupled to Host-to-PCI bridge 706 as well as host bus 702. Devices used solely by host processor(s) 700, such as LAN card 730, are coupled to PCI bus 710. Service Processor Interface and ISA Access Pass-through 712 provides an interface between PCI bus 710 and PCI bus 714. In this manner, PCI bus 714 is insulated from PCI bus 710. Devices, such as flash memory 718, are coupled to PCI bus 714. In one implementation, flash memory 718 includes BIOS code that incorporates the necessary processor executable code for a variety of low-level system functions and system boot functions.

PCI bus 714 provides an interface for a variety of devices that are shared by host processor(s) 700 and Service Processor 716 including, for example, flash memory 718. PCI-to-ISA bridge 735 provides bus control to handle transfers between PCI bus 714 and ISA bus 740, universal serial bus (USB) functionality 745, power management functionality 755, and can include other functional elements not shown, such as a real-time clock (RTC), DMA control, interrupt support, and system management bus support. Nonvolatile RAM 720 is attached to ISA Bus 740. Service Processor 716 includes JTAG and I2C busses 722 for communication with processor(s) 700 during initialization steps. JTAG/I2C busses 722 are also coupled to L2 cache 704, Host-to-PCI bridge 706, and main memory 708 providing a communications path between the processor, the Service Processor, the L2 cache, the Host-to-PCI bridge, and the main memory. Service Processor 716 also has access to system power resources for powering down information handling device 701.

Peripheral devices and input/output (I/O) devices can be attached to various interfaces (e.g., parallel interface 762, serial interface 764, keyboard interface 768, and mouse interface 770 coupled to ISA bus 740. Alternatively, many I/O devices can be accommodated by a super I/O controller (not shown) attached to ISA bus 740.

In order to attach computer system 701 to another computer system to copy files over a network, LAN card 730 is coupled to PCI bus 710. Similarly, to connect computer system 701 to an ISP to connect to the Internet using a telephone line connection, modem 775 is connected to serial port 764 and PCI-to-ISA Bridge 735.

While the computer system described in FIG. 7 is capable of executing the processes described herein, this computer system is simply one example of a computer system. Those skilled in the art will appreciate that many other computer system designs are capable of performing the processes described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer implemented method comprising:
receiving a record;
identifying a timestamp that corresponds to the record;
locating a table from a plurality of tables to store the record, the locating performed using the timestamp; and
storing the record in the located table.

2. The method as of claim 1 wherein the locating further comprises:
retrieving a time interval, the time interval corresponding to an amount of time associated with each of the plurality of tables;
retrieving a total tables number, the total tables number corresponding to the amount of the plurality of tables;
dividing the timestamp by the time interval, the dividing resulting in a product; and
dividing the product by the total tables number, the remainder corresponding to the located table.

3. The method of claim 1 further comprising:
receiving a report request, the report request corresponding to a timeframe;
retrieving a time interval, the time interval corresponding to an amount of time associated with each of the plurality of tables;
retrieving a total tables number, the total tables number corresponding to the amount of the plurality of tables;
dividing the timeframe by the time interval, the dividing resulting in a product;
dividing the product by the total tables number, the remainder corresponding to the located table; and
generating a report using one or more records that are included in the located table.

4. The method of claim 1 wherein the record includes the timestamp.

5. The method of claim 1 further comprising:
identifying an amount of records included in each of the plurality of tables;
determining whether to increase the number of tables based upon the identifying; and
increasing the amount of tables in response to the determination.

6. The method of claim 1 wherein the record includes at least one record field that is selected from the group consisting of a timestamp, a customer identifier, a customer name, and a note.

7. The method of claim 1 further comprising:
adding the timestamp to the record.

8. A program product comprising:
computer operable medium having computer program code, the computer program code being effective to:
receive a record;
identify a timestamp that corresponds to the record;
locate a table from a plurality of tables to store the record, the locating performed using the timestamp; and
store the record in the located table.

9. The program product of claim 8 wherein the computer program code is further effective to:
retrieve a time interval, the time interval corresponding to an amount of time associated with each of the plurality of tables;
retrieve a total tables number, the total tables number corresponding to the amount of the plurality of tables;
divide the timestamp by the time interval, the dividing resulting in a product; and
divide the product by the total tables number, the remainder corresponding to the located table.

10. The program product of claim 8 wherein the computer program code is further effective to:
receive a report request, the report request corresponding to a timeframe;
retrieve a time interval, the time interval corresponding to an amount of time associated with each of the plurality of tables;
retrieve a total tables number, the total tables number corresponding to the amount of the plurality of tables;
divide the timeframe by the time interval, the dividing resulting in a product;
divide the product by the total tables number, the remainder corresponding to the located table; and
generate a report using one or more records that are included in the located table.

11. The program product of claim 8 wherein the record includes the timestamp.

12. The program product of claim 8 wherein the computer program code is further effective to:
identify an amount of records included in each of the plurality of tables;
determine whether to increase the number of tables based upon the identifying; and
increase the amount of tables in response to the determination.

13. The program product of claim 8 wherein the record includes at least one record field that is selected from the group consisting of a timestamp, a customer identifier, a customer name, and a note.

14. The program product of claim 8 wherein the computer program code is further effective to:
add the timestamp to the record.

15. An information handling system comprising:
one or more processors;
a memory accessible by the processors;
one or more nonvolatile storage devices accessible by the processors; and
a record management tool for storing and retrieving records, the record management tool comprising software code effective to:
receive a record over a computer network;
identify a timestamp that corresponds to the record;
determine a table from a plurality of tables to store the record, the determining performed using the timestamp; and
store the record in the table that is located in one of the nonvolatile storage devices.

16. The information handling system of claim 15 wherein the software code is further effective to:
retrieve a time interval from one of the nonvolatile storage devices, the time interval corresponding to an amount of time associated with each of the plurality of tables;
retrieve a total tables number from one of the nonvolatile storage devices, the total tables number corresponding to the amount of the plurality of tables;
divide the timestamp by the time interval, the dividing resulting in a product; and
divide the product by the total tables number, the remainder corresponding to the table.

17. The information handling system of claim 15 wherein the software code is further effective to:
receive a report request over a computer network, the report request corresponding to a timeframe;
retrieve a time interval from one of the nonvolatile storage devices, the time interval corresponding to an amount of time associated with each of the plurality of tables;
retrieve a total tables number from one of the nonvolatile storage devices, the total tables number corresponding to the amount of the plurality of tables;
divide the timeframe by the time interval, the dividing resulting in a product;
divide the product by the total tables number, the remainder corresponding to the located table; and
generate a report using one or more records that are included in the located table.

18. The information handling system of claim 15 wherein the record includes the timestamp.

19. The information handling system of claim 15 wherein the software code is further effective to:
identify an amount of records included in each of the plurality of tables that are located in one of the nonvolatile storage devices;
determine whether to increase the number of tables based upon the identifying; and
increase the amount of tables in response to the determination.

20. The information handling system of claim 15 wherein the record includes at least one record field that is selected from the group consisting of a timestamp, a customer identifier, a customer name, and a note.
